(19) United States
(12) Patent Application Publication
(10) Pub. No.: US 2024/0249227 A1
(43) Pub. Date: Jul. 25, 2024

(54) UNIFIED DATA CATALOG

(71) Applicant: Wells Fargo Bank, N.A., San Francisco, CA (US)

(72) Inventors: Jagmohan Singh, Coppell, TX (US); Arefa Shaikh, East Brunswick, NJ (US); Matthew J. Barrett, Saint Paul, MN (US); Dae H. Lim, Charlotte, NC (US); Subodh K. Samal, Harrisburg, NC (US); Nathan P. Strickler, Johnston, IA (US)

(21) Appl. No.: 18/336,391

(22) Filed: Jun. 16, 2023

Related U.S. Application Data
(60) Provisional application No. 63/480,644, filed on Jan. 19, 2023.

(51) Int. Cl. G06Q 10/0635; G06F 9/54

(52) U.S. Cl. CPC G06Q 10/0635; G06F 9/547

(57) ABSTRACT

A computing system is configured to generate a data model comprising data sources, data use cases, and data governance policies retrieved from one or more data platforms via one or more platform and vendor agnostic APIs, wherein the data sources, data use cases, data governance policies, and APIs are aligned to one or more data domains. The computing system is further configured to create, based identifying information from the one or more data sources, a data linkage between a data source, a data use case, a data governance policy, and a data domain. The computing system is further configured to determine, based on the data governance policy and quality criteria, the level of quality of the data source. The computing system is further configured to generate, based on the level of quality of the data source, a report indicating the status of the data domain and data use case.

This application claims the benefit of U.S. Provisional Application No. 63/480,644, filed Jan. 19, 2023, the entire content of which is incorporated herein by reference.

### TECHNICAL FIELD

The disclosure relates to computer-based systems for managing data.

### BACKGROUND

A number of technology platforms exist that provide users or businesses the ability to collect and store large amounts of data. Such a platform may exist to provide users or businesses the ability to gain business insights on data. However, for many businesses, such as a bank, operational risks and security threats that can arise with data mismanagement must be minimized to maintain good industry standards and regulations that pertain to data collection and use. For example, Global Systemically Important Banks (G-SIB) are crucial players in the global financial system, but their size and complexity make them potential sources of systemic risk. Therefore, to avoid financial crises and promote the stability of the financial system, G-SIB banks are subject to strict data regulation requirements. These regulations mandate that G-SIB banks report, monitor, and analyze vast amounts of data relating to their risk exposures, capital adequacy, liquidity, and systemic importance. To safeguard sensitive data, G-SIB banks must comply with data protection laws and regulations. The fulfillment of these data regulation requirements is critical for G-SIB banks to maintain the confidence of their stakeholders, regulators, and the wider financial system. Thus, G-SIB banks and many other businesses may find it advantageous to impose stricter, more robust, and more automated data management practices or systems.

### SUMMARY

In general, this disclosure describes a computing system comprising a unified data catalog for managing data. The techniques described herein involve creating a view of the state of the data in an enterprise to provide transparency at the highest level of management, thus ensuring appropriate usage of data and that corrective actions be taken when necessary. The data catalog may utilize platform and vendor agnostic APIs to collect metadata from data platforms (including technical metadata, business metadata, data quality, and lineage, etc.), collect data use cases (including regulatory use cases, risk use cases, or operational use cases deployed on one or more data reporting platforms, data analytics platforms, data modeling platforms, etc.), and collect data governance policies or procedures and assessment outcomes (including one or more of data risks, data controls, or data issues retrieved from risk systems, etc.) from risk platforms. The data catalog may then define data domains aligned to a particular reporting structure, such as that used to report financial details in accordance with requirements established by the Security and Exchange Commission, or according to other enterprise-established guidelines. The data catalog may further build data insights, reporting, scorecards, and metrics for transparency on the status of data assets and corrective actions.

The techniques of this disclosure may provide one or more advantages over existing data management technologies that do not have a uniform, integrated data model for data risks, data controls, and/or a state of the union for data. For many businesses, data is often managed within multiple different teams by multiple different leaderships. As a result, data may be managed manually and in an ad hoc fashion by using multiple different nonconsolidated spreadsheets, emails, or sharepoints. The techniques of this disclosure may replace ad hoc enterprise data management repositories that were built using spreadsheets or sharepoints with a standard data model that automatically consolidates all data across a business. Further, the techniques of this disclosure may replace ad hoc data collection interfaces that were built using emails or SharePoint with standard APIs. As such, the techniques of this disclosure may ensure greater data quality, accuracy, and completeness while also improving the efficiency of data collection.

Another advantage of the techniques of this disclosure is that the computing system described herein may be sufficiently tailored to specific data usage tasks and may be able to rationalize all metadata, use cases, and risk assessments into a standard data model that is aligned to various data domains for executive-level management transparency. The computing system may also be sufficiently tailored to regulatory-friendly reporting capabilities, such as enabling management to gain business-specific insights. In other words, the computing system described herein may be configured to aggregate large amounts of data from a wide variety of data platforms or sources, create and analyze relationships between the aggregated data, and present information about those relationships via reports or the front-end so that a user or business can draw conclusions about the state of the data. For example, a regulatory report may currently source data from X number of data sources, but based on the insights provided by the unified data catalog, business management may conclude that Y data sources can be removed from the data flow, because those Y data sources are not adding any value to the data or the process. As a result, the data flow can be simplified to X−Y=Z data sources. In another example, a data domain may currently have X number of data provisioning points, but based on the insights provided by the unified data catalog, business management may conclude that Y data provisioning points can be decommissioned due to duplication of data provisioning. As a result, the number of data provisioning points can be simplifies to X−Y=Z data provisioning points.

The computing system may enable businesses to understand which data from various data sources is of appropriate quality to build accurate business reporting. The computing system may further help eliminate regulatory issues associated with improper adherence to data management policies and procedures.

In one example, the disclosure is directed to a computing system, comprising: a memory; a processing system comprising one or more processors in communication with the memory and configured to: generate a data model comprising one or more data sources, one or more data use cases, and one or more data governance policies retrieved from one or more of a plurality of data platforms via one or more of a plurality of platform and vendor agnostic application programming interfaces (APIs), wherein the one or more data sources, the one or more data use cases, the one or more data governance policies, and the one or more platform and vendor agnostic APIs are aligned to one or more data domains; create, based on information from the one or more data sources, a data linkage between one of the data sources, one of the data use cases, one of the data governance policies, and one of the data domains, wherein the data linkage is enforced by the platform and vendor agnostic API, wherein the data use case is monitored and controlled by a data use case owner, and wherein the data domain is monitored and controlled by a data domain executive; determine, based on the one or more data governance policies and quality criteria set forth by the data use case owner and the data domain executive, the level of quality of at least one of the one or more data sources; and generate, based on the level of quality of the data source, a report indicating the status of the data domain and data use case.

In another example, the disclosure is directed to a method comprising generating, by a computing system, a data model comprising one or more data sources, one or more data use cases, and one or more data governance policies retrieved from one or more of a plurality of data platforms via one or more of a plurality of platform and vendor agnostic application programming interfaces (APIs), wherein the one or more data sources, the one or more data use cases, the one or more data governance policies, and the one or more platform and vendor agnostic APIs are aligned to one or more data domains; creating, by the computing system and based information from the one or more data sources, a data linkage between one of the data sources, one of the data use cases, one of the data governance policies, and one of the data domains, wherein the data linkage is enforced by the platform and vendor agnostic API, wherein the data use case is monitored and controlled by a data use case owner, and wherein the data domain is monitored and controlled by a data domain executive; determining, by the computing system and based on the one or more data governance policies and quality criteria set forth by the data use case owner and the data domain executive, the level of quality of at least one of the one or more data sources; and generating, by the computing system and based on the level of quality of the data source, a report indicating the status of the data domain and data use case.

In another example, the disclosure is directed to a computer readable medium comprising instructions that when executed cause a processing system comprising one or more processors to: generate a data model comprising one or more data sources, one or more data use cases, and one or more data governance policies retrieved from one or more of a plurality of data platforms via one or more of a plurality of platform and vendor agnostic application programming interfaces (APIs), wherein the one or more data sources, the one or more data use cases, the one or more data governance policies, and the one or more platform and vendor agnostic APIs are aligned to one or more data domains; create, based on information from the one or more data sources, a data linkage between one of the data sources, one of the data use cases, one of the data governance policies, and one of the data domains, wherein the data linkage is enforced by the platform and vendor agnostic API, wherein the data use case is monitored and controlled by a data use case owner, and wherein the data domain is monitored and controlled by a data domain executive; determine, based on the one or more data governance policies and quality criteria set forth by the data use case owner and the data domain executive, the level of quality of at least one of the one or more data sources; and generate, based on the level of quality of the data source, a report indicating the status of the data domain and data use case.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a conceptual diagram illustrating an example system configured to generate a data model comprising one or more data sources, one or more data use cases, and one or more data governance policies retrieved from one or more of a plurality of data platforms via one or more of a plurality of platform and vendor agnostic APIs, in accordance with one or more techniques of this disclosure.

FIG. 2 is a block diagram illustrating an example system including vendor and platform agnostic APIs configured to ingest data, in accordance with one or more techniques of this disclosure.

FIG. 3 is a conceptual diagram illustrating an example system configured to generate, based on the level of quality of a data source, a report indicating the status of the data domain and data use case, in accordance with one or more techniques of this disclosure.

FIG. 4 is a block diagram illustrating an example system configured to generate a unified data catalog, in accordance with one or more techniques of this disclosure.

FIG. 5 is a flowchart illustrating an example process by which a computing system may generate a data model comprising one or more data sources, one or more data use cases, and one or more data governance policies retrieved from one or more of a plurality of data platforms via one or more of a plurality of platform and vendor agnostic APIs, in accordance with one or more techniques of this disclosure.

### DETAILED DESCRIPTION

In general, this disclosure describes a computing system configured to generate a comprehensive data model that includes one or more data sources, one or more data use cases, and one or more data governance policies. In some examples, the one or more data sources, one or more data use cases, and one or more data governance policies are retrieved from one or more of a plurality of data platforms via one or more platform and vendor agnostic application programming interfaces (APIs). The computing system may be designed in such a way that these APIs are aligned to one or more data domains, wherein one of the one or more platform and vendor agnostic APIs exists for each subject area of the data model (e.g., tech metadata, business metadata, data sources, use cases, data controls, data defects, etc.). In some examples, the computing system uses identifying information from the one or more data sources to create a data linkage between one of the data sources, one of the data use cases, one of the data governance policies, and one of the data domains. The data linkage may be enforced by the platform and vendor agnostic API, which ensures that the data sources are properly linked to their respective data use cases and data governance policies. Additionally, the data use case may be monitored and controlled by a data use case owner, and the data domain may be monitored and controlled by a data domain executive. This may ensure that the data is used correctly and that the data governance policies are followed. The computing system may use data governance policy and quality criteria set forth by the data use case owner and the data domain executive to determine the level of quality of a data source and ensure that the data being used is of high quality and suitable for its intended use case. Finally, based on the level of quality of the data source, the computing system may generate a report indicating the status of the data domain and data use case associated with that data source. This report may be used to evaluate the overall quality of the data and identify any issues that need to be addressed.

Overall, the computing system described herein may provide a comprehensive approach to managing data by consolidating and aligning data sources, data use cases, data governance policies, and APIs to specific data domains within a business. The computing system may also provide a way to link data sources to their respective data use cases and data governance policies, as well as a way to monitor and control the use of data by data use case owners and data domain executives. Additionally, the computing system may ensure the quality of data by evaluating data sources against set quality criteria and providing a report on the status of data domains and data use cases.

According to some aspects of the present disclosure, the vendor and platform agnostic APIs are configured to ingest data comprising a plurality of data structure formats.

According to some other aspects of the present disclosure, the one or more data use cases include one or more of a regulatory use case, a risk use case, or an operational use case deployed on one or more of a data reporting platform, a data analytics platform, or a data modeling platform. In some examples, the computing system grants access to the data use case owner to the data controls for one or more of the one or more data sources, wherein the one or more data sources are mapped to the data use case that is monitored and controlled by the data use case owner. In some examples, the computing system receives data indicating that the data use case owner has verified the data controls for the one or more data sources.

According to some other aspects of the present disclosure, the one or more data governance policies include one or more of data risks, data controls, or data issues retrieved from risk systems.

According to some other aspects of the present disclosure, the data domains are defined in accordance with enterprise-established guidelines. Each data domain may further comprise a sub-domain.

According to some other aspects of the present disclosure, creating the data linkage further comprises identifying, based on one or more data attributes, each of the one or more data sources; determining the necessary data controls for each of the one or more data sources; and mapping each of the one or more data sources to one or more of the one or more data use cases, the one or more data governance policies, or the one or more data domains.

According to some aspects of the present disclosure, the generated report further indicates one or more of the number of data sources determined to have the necessary level of quality, the number of data sources approved by the data domain executive, or the number of use cases using data sources approved by the data domain executive.

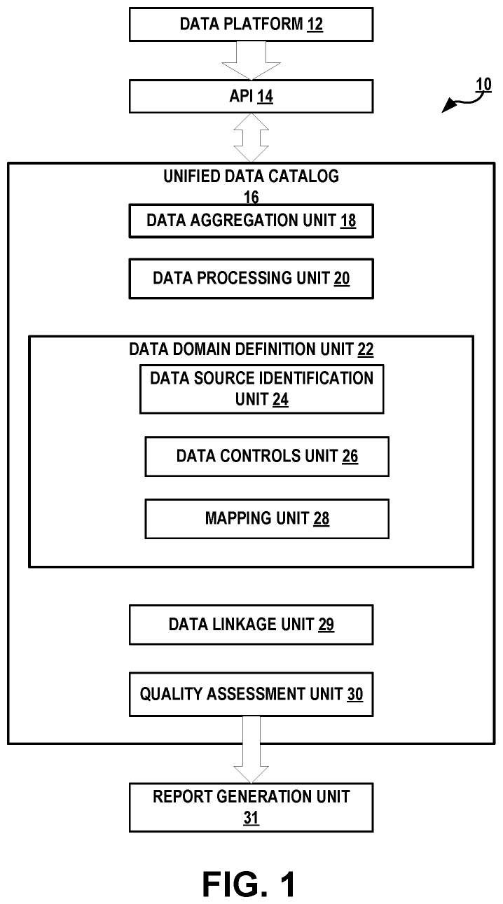

FIG. 1 is a conceptual diagram illustrating an example system configured to generate a data model comprising data sources, data use cases, and data governance policies retrieved from one or more of a plurality of data platforms via one or more of a plurality of platform and vendor agnostic APIs, in accordance with one or more techniques of this disclosure. In the example of FIG. 1, system 10 is configured to generate unified data catalog 16. Unified data catalog 16 is configured to retrieve one or more data sources, one or more data use cases, and one or more data governance policies from one or more of a plurality of data platforms 12 via one or more of a plurality of platform and vendor agnostic APIs 14. Unified data catalog 16 further includes data aggregation unit 18. In some examples, data aggregation unit 18 collects, integrates, and consolidates data from one or more data platforms 12 via APIs 14 into a single, unified format or view. In some examples, data aggregation unit 18 retrieves data from data platforms 12 using various data extraction methods, such as SQL queries, web scraping, and file parsing.

Unified data catalog 16 further includes data processing unit 20. In some examples, data processing unit 20 is configured to filter and sort data that has been aggregated by data aggregation unit 18. Data processing unit 20 may also clean, validate, normalize, and/or transform data such that it is consistent, accurate, and understandable. For example, data processing unit 20 may perform a quality check on the consolidated data by applying validation rules and data quality metrics to ensure that the data is accurate and complete. In some examples, data processing unit 20 may output the consolidated data in a format that can be easily consumed by other downstream systems, such as a data warehouse, a business intelligence tool, or a machine learning model. Data processing unit 20 may also be configured to maintain the data governance policies and procedures set forth by an enterprise for data lineage, data security, data privacy, and data audit trails. In some examples, data processing unit 20 is responsible for identifying and handling any errors that occur during the data collection, integration, and consolidation process. For example, data processing unit 20 may log errors, alert administrators, and/or implement error recovery procedures. Data processing unit 20 may also ensure optimal performance of the system by monitoring system resource usage and implementing performance optimization techniques such as data caching, indexing, and/or partitioning.

In some examples, existing data management sources, use cases, and controls may be integrated into unified data catalog 16 to prevent disruption of any existing processes. In some examples, ongoing maintenance for data management sources, used cases, and controls may be provided for unified data catalog 16. In some examples, data quality checks and approval mechanisms may be provided for ensuring that data loaded into unified data catalog 16 is accurate. In some examples, unified data catalog 16 may utilize machine learning capabilities to rationalize data. In some examples, unified data catalog 16 may use a manual process to rationalize data. In some examples, unified data catalog 16 may implement a server-based portal for confirmation/approval workflows to confirm data.

Unified data catalog 16 further includes data domain definition unit 22 that includes data source identification unit 24, data controls unit 26, and mapping unit 28. Data source identification unit 24 maybe configured to identify one or more data platforms 12 associated with data that has been aggregated by data aggregation unit 18 and processed by data processing unit 20. For example, data source identification unit 24 may identify a data platform or source associated with a portion of data by scanning for specific file types or by searching for specific keywords within a file or database. Data source identification unit 24 may identify the key characteristics and attributes of the data. Data source identification unit 24 may further be used to ensure data governance and compliance by identifying and classifying sensitive or confidential data. In some examples, data source identification unit 24 maybe used to identify and remove duplicate data as well as to generate metadata about the identified data platforms or sources, such as the data's creator, creation date, and/or last modification date.

Data controls unit 26 maybe configured to identify the specific security and privacy controls that are required to protect data. Data controls unit 26 may also be configured to determine the specific area or subject matter that the controls are related to. For example, if a data source contains sensitive personal information such as credit card numbers, social security numbers, or medical records, the data would be considered sensitive data and would be subject to regulatory compliance such as HIPAA, PCI-DSS, or GDPR. In some examples, data controls unit 26 may identify specific security controls such as access control, encryption, and data loss prevention that are required to protect the data from unauthorized access, disclosure, alteration, or destruction. Data controls unit 26 may generate metadata about the necessary data controls, such as the data control type. In some examples, data controls unit 26 may further ensure that the data outputted by data processing unit 20 meets a certain quality threshold. For example, if the specific subject matter determined by data controls unit 26 is social security numbers, data controls unit 26 may check if any non-nine-digit numbers or duplicate numbers exist. Further processing or cleaning may be applied to the data responsive to data controls unit 26 determining that the data does not meet a certain quality threshold.

In some examples, all data sources are documented by unified data catalog 16, and all data quality controls are built around data source domains. In some examples, data controls unit 26 may determine that the right controls do not exist, which may result in an open control issue. For example, responsive to data controls unit 26 determining that the right controls do not exist, an action plan aligned to the control issue may be executed by a data use case owner to resolve the control issue. In some examples, data controls may be built around data use cases and/or data sources, in which the data use case owner may verify that the correct controls are in place. In some examples, the data use case owner is granted access to the data controls for the one or more data sources that are mapped to the data use case that is monitored and controlled by the data use case owner. Responsive to the data use case owner verifying the data controls for the one or more data sources, the computing system may receive data indicating that the data use case owner has verified the data controls. In some examples, a machine learning model may be implemented by data controls unit 26 to determine whether the correct controls exist, enough controls exist, and/or whether any controls are missing.

Mapping unit 28 maybe configured to map data to a specific data domain based on information identified by data source identification unit 24 and data controls unit 26. For example, if data source identification unit 24 and data controls unit 26 determine that a portion of data is sourced from patient medical records and is assigned to regulatory compliance such as HIPAA, mapping unit 28 may determine the data domain to be healthcare. In some examples, mapping unit 28 may assign a code or identifier to the data that is then used to create automatic data linkages between data sources, data use cases, data governance policies, and data domains pertaining to the data. In some examples, mapping unit 28 may generate other data elements or attributes that are used to create data linkages. In some examples, a machine learning model may be implemented by mapping unit 28 to determine the data domain for each data source.

Taken together, data domain definition unit 22 may define a data domain specifying an area of knowledge or subject matter that a portion of data relates to. Once the data domain is defined by data domain definition unit 22, the data domain can be used to guide decisions for data governance, data management, and data security. The data domain may also be used to ensure that the data is used in compliance with regulatory requirements and to help identify any potential regulatory or compliance issues related to the data within that data domain. Additionally, the data domain may help to identify any additional data controls that may be needed to protect the data. In some examples, the data domains may be pre-defined. For example, a business may define data domains that are aligned to the Wall Street reporting structure and the operating committee level executive management structure to prior to tying all metadata, use cases, and risk assessments to their respective data domains. In some examples, multiple data domains may exist, in which each domain includes identified data sources, written controls, mapped appropriate use cases, a list of uses cases with associated controls/accountability, and a report that provides the status of the domain (e.g., how many and/or which use cases are using approved data sources).

In some examples, data domain definition unit 22 may also identify specific sub-domains within a larger data domain. For example, within a finance domain, there may be sub-domains such as investments, banking, and accounting. For example, within a healthcare domain, there may be sub-domains such as cardiovascular health, mental health, and pediatrics.

Unified data catalog 16 further includes data linkage unit 29 that may be configured to create a data linkage between one of the data sources, one of the data use cases, one of the data governance policies, and one of the data domains. Unified data catalog 16 may unify multiple components together, i.e., unified data catalog 16 may establish linkages between various components that used to be scattered. More specifically, data linkage unit 29 may connect data from various sources by identifying relationships between data sets or elements. In some examples, data linkage unit 29 may identify relationships between data sources, data use cases, data governance policies, and data domains based on identifying information included in the data or metadata. For example, data source identification unit 24 may identify the key attributes of the data and data controls unit 26 may identify the correct data controls based on the key attributes of the data. Mapping unit 28 may then be used to generate data attributes or elements that indicate a specific data domain based on the information identified by data source identification unit 24 and data controls unit 26. Data linkage unit 29 may then automatically create data linkages between data sources, data use cases, data governance policies, and data domains based on the data domain that mapping unit 28 has aligned the data to. In some examples, data linkage unit 29 may improve data quality by also identifying and rectifying errors or inconsistencies in the data that prevent linkages from being created.

By creating these automatic data linkages, unified data catalog 16 may provide a more efficient and organized means of ingesting large amounts of data. For example, 5000 data sources belonging to 7 different domains may be ingested into unified data catalog 16, in which the linkages between all the data sources and all the data domains are created automatically by data linkage unit 29. Further, the automatic data linkages created by data linkage unit 29 may provide a more comprehensive understanding of the data and its context. For example, linking data from various sources such as customer purchase history, customer demographic data, and customer online activity can provide a deeper understanding of customer behavior and preferences.

In some examples, the data linkages created by data linkage unit 29 are enforced by platform and vendor agnostic APIs 14. For example, a single API may be constructed for each data domain that has built-in hooks for direct connection into a repository of data sources associated with a particular data domain. In some examples, the APIs may be designed to enable the exchanging of data in a standardized format. For example, the APIs may support REST (Representational State Transfer), which is a widely-used architectural style for building APIs that use HTTP (Hypertext Transfer Protocol) to exchange data between applications. REST APIs enable data to be exchanged in a standardized format, which may then enable data linkages to be created more easily and efficiently. In some examples, some data linkages may need to be manually created by a data use case owner who monitors and controls the data use case and/or by the data domain executive who monitors and controls the data domain.

Unified data catalog 16 further includes quality assessment unit 30 that may be configured to determine, based on the data governance policy and quality criteria set forth by the data use case owner and the data domain executive, the level of quality of the data source. In some examples, a machine learning model may be implemented by quality assessment unit 30 to determine a numerical score for each data source that indicates the level of quality of the data source. In some examples, data sources may also be sorted into risk tiers by quality assessment 30, wherein certain risk tiers indicate that a data source is approved and/or usable, which may be based on the numerical score exceeding a required threshold set forth by the data use case owner and/or the data domain executive. In some examples, the data use case owner and/or the data domain executive may be required to manually fix any data source that receives a numerical score less than the required threshold.

Unified data catalog 16 may output data relating to a data source to report generation unit 31. In some examples, report generation unit 31 may generate, based on the level of quality of the data source, a report indicating the status of the data domain and data use case. For example, in the case of a mortgage, a form (i.e., a source document) may be submitted to a loan officer. All data flows may start from the source document, wherein the source document is first entered into an origination system and later moved into an aggregation system (in which customer data may be brought in and aggregated with the source document). A report may need to be provided to regulators that states whether discrimination occurred during the flow of data. Well-defined criteria may need to be used to determine whether discrimination occurred, such as criteria for data quality (based on, for example, entry mistakes, data translation mistakes, data loss, ambiguous data, negative interest rates). Further, publishing and marketing of data may have different data quality criteria. As such, data controls may need to be implemented to ensure proper data use. In this example, report generation unit 31 may generate a report indicating the status of the mortgage domain, the publishing use case, and the marketing use case based on the quality of the source document.

Unified data catalog 16 may build data insights, reporting, scorecards, and metrics for transparency on the status of data assets and corrective actions to provide executive level accountability for data quality, data risks, data controls, and data issues. In some examples, unified data catalog 16 may include a domain “scoreboard” or dashboard that provides an on-demand report of data stored within unified data catalog 16. For example, the domain dashboard may show each data source with its associated policy designation, domain, sub-domain, and app business owner. Unified data catalog 16 may further classify each data use case, data source, and data control. The domain dashboard may further define and inventory data domains.

In this way, unified data catalog 16 may provide users and/or businesses an insightful and organized view of data that may aid in making business decisions. Additionally, the reporting capabilities of unified data catalog 16 may aid in simplifying data flows, as the insights provided by unified data catalog 16 may identify which data sources are of low quality or have little value add to a certain process.

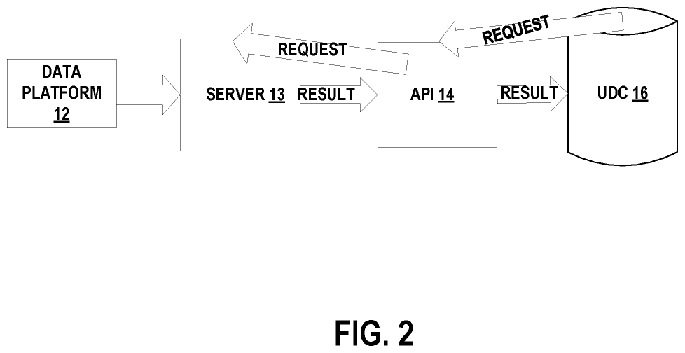

FIG. 2 is a block diagram illustrating an example system including vendor and platform agnostic APIs configured to ingest data, in accordance with one or more techniques of this disclosure. One API may exist per data domain or subject matter (e.g., the same API may be used for a bulk upload or manual entry of data). In the example of FIG. 2, unified data catalog 16 establishes a connection to data platform 12 via platform and vendor agnostic APIs 14 and server 13. APIs 14, in accordance with the techniques described herein, may be APIs that are not tied to a specific platform or vendor, i.e., APIs 14 maybe designed to function across multiple different platforms and technologies, regardless of the vendor used. For example, APIs 14 maybe designed to function across different types of hardware and software platforms, such as Windows, Linux, or MacOS, or any other type of platform that supports the API. APIs 14 may further be designed to function across different vendors' products, i.e., APIs 14 are not specific to a particular vendor and can be used to connect to different products from different vendors. Thus, APIs 14 may provide a consistent and standardized way of accessing data across different data platforms 12, regardless of the vendor or technology used. APIs 14 maybe used to bring all data into a rationalized and structured data model to link data sources, application owners, and domain executives. APIs 14 may allow unified data catalog 16 to connect to different data platforms 12 which may be, but are not limited to, databases, data warehouses, data lakes, and cloud storage systems, in a consistent and uniform manner. APIs 14 may collect metadata, data use cases, and/or data governance policies or procedures and assessment outcomes from data platforms 12. Data platforms 12 maybe any reporting, analytical, modeling, or risk platforms.

In the example of FIG. 2, a request may be sent by a client, such as a user or an application of unified data catalog 16, to server 13. The request may be a simple query, a command to retrieve data, or a request for access to a specific data platform 12. API 14 may receive the request from unified data catalog 16 first before translating the request and sending it to server 13. Upon receiving the request from API 14, server 13 may process the request and may access data platform 12 to retrieve the requested data. Server 13 may then send data back to the API 14, which may format the data into a standardized format that unified data catalog 16 can understand or ingest. API 14 may then send the data to unified data catalog 16, wherein unified data catalog 16 may then store the received data.

APIs 14 maybe further configured to support authentication and authorization procedures, which may help ensure that data is accessed and used in accordance with governance policies and regulations. For example, APIs 14 may define and enforce rules for data access and usage that ensure only authorized users are able to access certain data and that all data is stored and processed in compliance with regulatory requirements.

In some examples, an automated data management framework may be implemented to perform automatic metadata harvesting while utilizing the same API. In some examples, external tools may be used to pull in data. In some examples, unified data catalog 16 may include different data domains with preestablished links that are enforced via APIs 14. For example, a technical metadata API may create an automatic data linkage for all technical metadata pertaining to the same data domain. The automated data management framework may further automate the collection of metadata, data use cases, and risk assessment outcomes into unified data catalog 16. The automated data management framework may also automate a user interface to maintain and provide updates on the contents of unified data catalog 16. The automated data management framework may also provide a feature to automatically manage data domains defined in accordance with enterprise-established guidelines (e.g., the Wall Street reporting structure and the Wells Fargo operating committee level executive management structure). The automated data management framework may also automate approval workflows that align the contents of unified data catalog 16 to the different data domains. The automated data management framework may be applied to G-SIB banks, but may also be applied to any regulated industry (Financial Services, Healthcare, etc.).

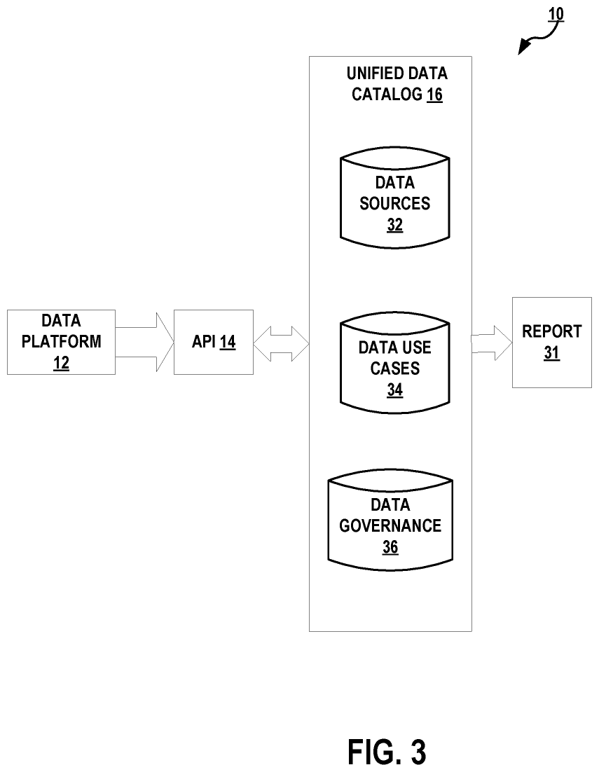

FIG. 3 is a conceptual diagram illustrating another view of example system 10 configured to generate, based on the level of quality of a data source, a report indicating the status of the data domain and data use case, in accordance with one or more techniques of this disclosure. In the example of FIG. 3, unified data catalog 16 includes data sources storage unit 32, data use cases storage unit 34, and data governance storage unit 36. System 10 of FIG. 1 may operate substantially similar to system 10 of FIG. 3, and both may include the same components. Data sources storage unit 32 maybe configured to store and manage data sources within unified data catalog 16. Data sources storage unit 32 may serve as a central repository for data sources that are retrieved from data platforms 12 via APIs 14, allowing users to discover, understand, and access data from data platforms 12 without needing to know the specific technical details of each platform. Data sources storage unit 32 maybe configured to store data sources in a variety of formats, such as structured, semi-structured, and unstructured data. Data sources storage unit 32 may also store data sources in different storage systems, such as relational databases, data lakes, or cloud storage. Data sources storage unit 32 maybe configured to handle large amounts of data while meeting scalability and performance requirements. Data sources storage unit 32 may also provide a secure and controlled access to data sources by implementing access control mechanisms such as role-based access control, data masking, and encryption to protect the data from unauthorized access, disclosure, alteration, or destruction. Additionally, data sources storage unit 32 may provide a way to version the data sources, and track changes to the data over time. Data sources storage unit 32 may also support data lineage, or provide information about where the data came from, how it was processed, and how it was used.

In some examples, technical metadata may be pulled into unified data catalog 16 from a data store via APIs 14. The technical metadata may undergo data aggregation, data processing, data controls identification, data mapping, and data domain alignment as described with respect to FIG. 1. The technical metadata may include a group of data attributes, such the relationship with the data store. The technical metadata may also be stored in data sources storage unit 32. In another example, business metadata may also be pulled into unified data catalog 16 via APIs 14. The business metadata may define business data elements for physical data elements in the technical metadata. In other words, the business metadata may provide context about the data in terms of its meaning, usage, and relevance to the business while the technical metadata describes the physical data elements or technical aspects of the data, such as its format, type, lineage, and quality. The business metadata may also undergo data aggregation, data processing, data controls identification, data mapping, and data domain alignment as described with respect to FIG. 1. As such, unified data catalog 16 may consolidate and link business metadata utilized by business analysts and data scientists with technical metadata utilized by database administrators, data architects, or other IT professionals upon determining that the technical metadata and business metadata are aligned to the same data domain.

In some examples, upon sending a request to APIs 14 to pull in business metadata, an additional operation may be performed to check if a linked physical data element already exists. In some examples, upon sending a request to APIs 14 to pull in a physical data element, an additional operation may be performed to check if a dataset and data store already exists. In some examples, if a data linkage is not identified, an error message may be generated. In some examples, if certain metadata cannot be loaded, a flag may be set to reject the entire file containing the metadata.

Data use cases storage unit 34 of unified data catalog 16 maybe configured to store data containing information pertaining to various data use cases within an organization. In some examples, data use cases storage unit 34 stores data including use case identification information (e.g., the name, description, and type of the use case). As such, data use cases storage unit 34 may allow for easy discovery, management, and governance of data use cases by providing a unified view of all relevant information pertaining to data usage. The data use case data may undergo data aggregation, data processing, data controls identification, data mapping, and data domain alignment as described with respect to FIG. 1. In some examples, users of unified data catalog 16 may search for specific use cases by name or browse by specific categories. In some examples, users of unified data catalog 16 may also submit new use cases for review and approval by data use case owners and/or domain executives.

Data governance storage unit 36 of unified data catalog 16 maybe configured to store data containing information pertaining to the management and oversight of data within an organization. In some examples, data governance storage unit 36 may store data including information indicating data ownership, data lineage, data quality, data security, data policies, and assessed risk. Data governance storage unit 36 may allow for easy management and enforcement of data governance policies by providing a unified view of all relevant information pertaining to data governance. The data governance data may undergo data aggregation, data processing, data controls identification, data mapping, and data domain alignment as described with respect to FIG. 1. In some examples, user of unified data catalog 16 may submit new governance policies for review and approval by data use case owners and/or data domain executives. Additionally, data governance storage unit 36 maybe configured to monitor compliance with governance policies within unified data catalog 16 and identify any potential violations. Data governance storage unit 36 may also store information relating to compliance and governance activities and provide an auditable trail of all changes made to any policies within unified data catalog 16.

Taken together, unified data catalog 16 may output information relating to a data source or platform to report generation unit 31 that is based on the data linkage created between the data source or platform and the data use cases, data governance policies, and data domains by unified data platform 16. For example, with respect to FIGS. 1 and 2, upon a portion of data being retrieved from data platform 12 via API 14, the portion of data may undergo data aggregation, data processing, data controls identification, data mapping, and data domain alignment. The portion of data may then undergo a data linkage in which the data is linked to other portions of data that are aligned to the same data domain and/or data use cases and data governance policies that are aligned to the same data domain. Each step may be performed in accordance with the information stored in data sources storage unit 32, data use cases storage unit 34, and data governance storage unit 36. The portion of data may further undergo a quality assessment. Upon determining the level of quality of the portion of data based on the information stored in data sources storage unit 32, data use cases storage unit 34, and data governance storage unit 36, report generation unit 31 may generate a report indicating the status of the data domain aligned to the portion of data and the data use case linked to the portion of data. The report may also indicate the quality and credibility of the data source or platform from which the portion of data was retrieved. As such, users of unified data catalog 16 may gain a better understanding of relationships between the data and which data are lacking in value, which ultimately may aid in gaining better understanding of the state of the data and better business insights.

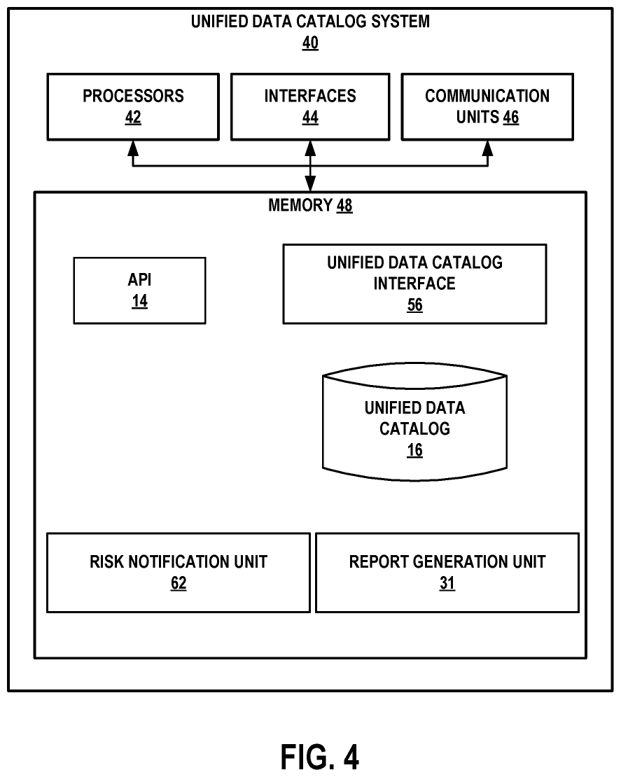

FIG. 4 is a block diagram illustrating an example system configured to generate a unified data catalog, in accordance with one or more techniques of this disclosure. In the example of FIG. 4, unified data catalog system 40 includes one or more processors 42, one or more interfaces 44, one or more communication units 46, and one or more memory units 48. Unified data catalog system 40 further includes API unit 14, unified data catalog interface unit 56, unified data catalog storage unit 16, risk notification unit 62, and report generation unit 31, each of which may be implemented as program instructions and/or data stored in memory 48 and executable by processors 42 or implemented as one or more hardware units or devices of unified data catalog system 40. Memory 48 of unified data catalog system 40 may also store an operating system (not shown) executable by processors 42 to control the operation of components of unified data catalog system 40. Although not shown in FIG. 4, the components, units, or modules of unified data catalog system 40 are coupled (physically, communicatively, and/or operatively) using communication channels for inter-component communications. In some examples, the communication channels may include a system bus, a network connection, an inter-process communication data structure, or any other method for communicating data.

Processors 42, in one example, may comprise one or more processors that are configured to implement functionality and/or process instructions for execution within unified data catalog system 40. For example, processors 42 maybe capable of processing instructions stored by memory 48. Processors 42 may include, for example, microprocessors, digital signal processors (DSPs), application specific integrated circuits (ASICs), field-programmable gate array (FPGAs), or equivalent discrete or integrated logic circuitry, or a combination of any of the foregoing devices or circuitry.

Memory 48 maybe configured to store information within unified data catalog system 40 during operation. Memory 48 may include a computer-readable storage medium or computer-readable storage device. In some examples, memory 48 includes one or more of a short-term memory or a long-term memory. Memory 48 may include, for example, random access memories (RAM), dynamic random access memories (DRAM), static random access memories (SRAM), magnetic discs, optical discs, flash memories, or forms of electrically programmable memories (EPROM) or electrically erasable and programmable memories (EEPROM). In some examples, memory 48 is used to store program instructions for execution by processors 42. Memory 48 maybe used by software or applications running on unified data catalog system 40 to temporarily store information during program execution.

Unified data catalog system 40 may utilize communication units 46 to communicate with external devices via one or more networks. Communication units 46 maybe network interfaces, such as Ethernet interfaces, optical transceivers, radio frequency (RF) transceivers, or any other type of devices that can send and receive information. Other examples of such network interfaces may include Wi-Fi, NFC, or Bluetooth® radios. In some examples, unified data catalog system 40 utilizes communication unit 46 to communicate with external data stores via one or more networks.

Unified data catalog system 40 may utilize interfaces 44 to communicate with external systems or user computing devices via one or more networks. The communication may be wired, wireless, or any combination thereof. Interfaces 44 maybe network interfaces (such as Ethernet interfaces, optical transceivers, radio frequency (RF) transceivers, Wi-Fi or Bluetooth radios, or the like), telephony interfaces, or any other type of devices that can send and receive information. Interfaces 44 may also be output by unified data catalog system 40 and displayed on user computing devices. More specifically, interfaces 44 maybe generated by unified data catalog interface 56 of unified data catalog system 40 and displayed on user computing devices. Interfaces 44 may include, for example, a GUI that allows users to access and interact with unified data catalog system 40, wherein interacting with unified data catalog system 40 may include actions such as requesting data, searching data, storing data, transforming data, analyzing data, visualizing data, and collaborating with other user computing devices.

Risk notification unit 62 may generate alerts or messages to administrators upon the detection of any risks within unified data catalog system 40. For example, upon data processing unit 20 logging a particular error, risk notification unit 62 may send a message to alert administrators of unified data catalog system 40. In another example, upon certain metadata not being able to be loaded into unified data catalog system 40, risk notification unit 62 may generate a message to administrators that indicates the entire file containing the metadata should be rejected.

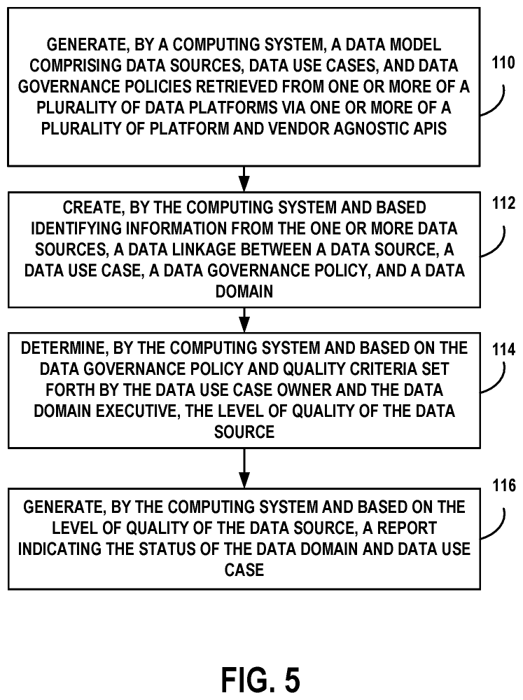

FIG. 5 is a flowchart illustrating an example process by which a computing system may generate a data model comprising data sources, data use cases, and data governance policies retrieved from one or more of a plurality of data platforms via one or more of a plurality of platform and vendor agnostic APIs, in accordance with one or more techniques of this disclosure. The technique of FIG. 5 may first include generating, by a computing system, a data model comprising data sources, data use cases, and data governance policies retrieved from one or more of a plurality of data platforms via one or more of a plurality of platform and vendor agnostic APIs (110). The data sources, data use cases, data governance policies, and APIs are aligned to one or more of a plurality of data domains. One vendor and platform agnostic API may exist for each data domain or subject area of the data model. The technique further includes creating, by the computing system and based identifying information from the one or more data sources, a data linkage between a data source, a data use case, a data governance policy, and a data domain (112). The data linkage is enforced by the platform and vendor agnostic API. The data use case is monitored and controlled by a data use case owner and the data domain is monitored and controlled by a data domain executive. The technique further includes determining, by the computing system and based on the data governance policy and quality criteria set forth by the data use case owner and the data domain executive, the level of quality of the data source (114). The technique further includes generating, by the computing system and based on the level of quality of the data source, a report indicating the status of the data domain and data use case (116).

The techniques described in this disclosure may be implemented, at least in part, in hardware, software, firmware or any combination thereof. For example, various aspects of the described techniques may be implemented within a processing system comprising one or more processors, including one or more microprocessors, digital signal processors (DSPs), application specific integrated circuits (ASICs), field programmable gate arrays (FPGAs), or any other equivalent integrated or discrete logic circuitry, as well as any combinations of such components. The term “processor” or “processing circuitry” may generally refer to any of the foregoing logic circuitry, alone or in combination with other logic circuitry, or any other equivalent circuitry. A control unit comprising hardware may also perform one or more of the techniques of this disclosure.

Such hardware, software, and firmware may be implemented within the same device or within separate devices to support the various operations and functions described in this disclosure. In addition, any of the described units, modules or components may be implemented together or separately as discrete but interoperable logic devices. Depiction of different features as modules or units is intended to highlight different functional aspects and does not necessarily imply that such modules or units must be realized by separate hardware or software components. Rather, functionality associated with one or more modules or units may be performed by separate hardware or software components, or integrated within common or separate hardware or software components.

The techniques described in this disclosure may also be embodied or encoded in a computer-readable medium, such as a computer-readable storage medium, containing instructions. Instructions embedded or encoded in a computer-readable medium may cause a programmable processor, or other processor, to perform the method, e.g., when the instructions are executed. Computer-readable media may include non-transitory computer-readable storage media and transient communication media. Computer readable storage media, which is tangible and non-transitory, may include random access memory (RAM), read only memory (ROM), programmable read only memory (PROM), erasable programmable read only memory (EPROM), electronically erasable programmable read only memory (EEPROM), flash memory, a hard disk, a CD-ROM, a floppy disk, a cassette, magnetic media, optical media, or other computer-readable storage media. It should be understood that the term “computer-readable storage media” refers to physical storage media, and not signals, carrier waves, or other transient media.

What is claimed is:

1. A computing system, comprising:
a memory;
a processing system comprising one or more processors, wherein the processing system is in communication with the memory and configured to:
generate a data model comprising one or more data sources, one or more data use cases, and one or more data governance policies retrieved from one or more of a plurality of data platforms via one or more of a plurality of platform and vendor agnostic application programming interfaces (APIs), wherein the one or more data sources, the one or more data use cases, the one or more data governance policies, and the one or more platform and vendor agnostic APIs are aligned to one or more data domains;
create, based on information from the one or more data sources, a data linkage between one of the data sources, one of the data use cases, one of the data governance policies, and one of the data domains, wherein the data linkage is enforced by the platform and vendor agnostic API, wherein the data use case is monitored and controlled by a data use case owner, and wherein the data domain is monitored and controlled by a data domain executive;
determine, based on the one or more data governance policies and quality criteria set forth by the data use case owner and the data domain executive, the level of quality of at least one of the one or more data sources; and
generate, based on the level of quality of the data source, a report indicating the status of the data domain and data use case.

2. The computing system of claim 1, wherein the platform and vendor agnostic APIs are configured to ingest data comprising a plurality of data structure formats.

3. The computing system of claim 1, wherein the one or more data use cases include one or more of a regulatory use case, a risk use case, or an operational use case deployed on one or more of a data reporting platform, a data analytics platform, or a data modeling platform.

4. The computing system of claim 1, wherein the one or more data governance policies include one or more of data risks, data controls, or data issues retrieved from risk systems.

5. The computing system of claim 1, wherein the one or more data domains are defined in accordance with enterprise-established guidelines.

6. The computing system of claim 5, wherein each data domain comprises a sub-domain.

7. The computing system of claim 1, wherein to create the data linkage, the processing system is further configured to:
identify, based on one or more data attributes, each of the one or more data sources;
determine the necessary data controls for each of the one or more data sources; and
map each of the one or more data sources to one or more of the one or more data use cases, the one or more data governance policies, or the one or more data domains.

8. The computing system of claim 7, wherein the processing system is further configured to:
grant access to the data use case owner to the data controls for one or more of the one or more data sources, wherein the one or more data sources are mapped to the data use case that is monitored and controlled by the data use case owner; and
receive data indicating that the data use case owner has verified the data controls for the one or more data sources.

9. The computing system of claim 1, wherein the generated report further indicates one or more of the number of data sources determined to have the necessary level of quality, the number of data sources approved by the data domain executive, or the number of use cases using data sources approved by the data domain executive.

10. A method comprising:
generating, by a computing system, a data model comprising one or more data sources, one or more data use cases, and one or more data governance policies retrieved from one or more of a plurality of data platforms via one or more of a plurality of platform and vendor agnostic application programming interfaces (APIs), wherein the one or more data sources, the one or more data use cases, the one or more data governance policies, and the one or more platform and vendor agnostic APIs are aligned to one or more data domains;
creating, by the computing system and based information from the one or more data sources, a data linkage between one of the data sources, one of the data use cases, one of the data governance policies, and one of the data domains, wherein the data linkage is enforced by the platform and vendor agnostic API, wherein the data use case is monitored and controlled by a data use case owner, and wherein the data domain is monitored and controlled by a data domain executive;
determining, by the computing system and based on the one or more data governance policies and quality criteria set forth by the data use case owner and the data domain executive, the level of quality of at least one of the one or more data sources; and
generating, by the computing system and based on the level of quality of the data source, a report indicating the status of the data domain and data use case.

11. The method of claim 10, wherein the platform and vendor agnostic APIs are configured to ingest data comprising a plurality of data structure formats.

12. The method of claim 10, wherein the one or more data use cases include one or more of a regulatory use case, a risk use case, or an operational use case deployed on one or more of a data reporting platform, a data analytics platform, or a data modeling platform.

13. The method of claim 10, wherein the one or more data governance policies include one or more of data risks, data controls, or data issues retrieved from risk systems.

14. The method of claim 10, wherein the one or more data domains are defined in accordance with enterprise-established guidelines.

15. The method of claim 14, wherein each data domain comprises a sub-domain.

16. The method of claim 10, wherein to creating the data linkage further comprises:
identifying, by the computing system, based on one or more data attributes, each of the one or more data sources;
determining, by the computing system, the necessary data controls for each of the one or more data sources; and
mapping, by the computing system, each of the one or more data sources to one or more of the one or more data use cases, the one or more data governance policies, or the one or more data domains.

17. The method of claim 16, further comprising:
granting, by the computing system and to the data use case owner, access to the data controls for one or more of the one or more data sources, wherein the one or more data sources are mapped to the data use case that is monitored and controlled by the data use case owner; and
receiving, by the computing system, data indicating that the data use case owner has verified the data controls for the one or more data sources.

18. The method of claim 10, wherein the generated report further indicates one or more of the number of data sources determined to have the necessary level of quality, the number of data sources approved by the data domain executive, or the number of use cases using data sources approved by the data domain executive.

19. A computer readable medium comprising instructions that when executed cause a processing system comprising one or more processors to:
generate a data model comprising one or more data sources, one or more data use cases, and one or more data governance policies retrieved from one or more of a plurality of data platforms via one or more of a plurality of platform and vendor agnostic application programming interfaces (APIs), wherein the one or more data sources, the one or more data use cases, the one or more data governance policies, and the one or more platform and vendor agnostic APIs are aligned to one or more data domains;
create, based on information from the one or more data sources, a data linkage between one of the data sources, one of the data use cases, one of the data governance policies, and one of the data domains, wherein the data linkage is enforced by the platform and vendor agnostic API, wherein the data use case is monitored and controlled by a data use case owner, and wherein the data domain is monitored and controlled by a data domain executive;
determine, based on the one or more data governance policies and quality criteria set forth by the data use case owner and the data domain executive, the level of quality of at least one of the one or more data sources; and
generate, based on the level of quality of the data source, a report indicating the status of the data domain and data use case.

20. The computer readable medium of claim 19, further comprising instructions that when executed cause the processing system to:
identify, based on one or more data attributes, each of the one or more data sources;
determine the necessary data controls for each of the one or more data sources; and
map each of the one or more data sources to one or more of the one or more data use cases, the one or more data governance policies, or the one or more data domains.
